(19) United States
(12) Patent Application Publication
(10) Pub. No.: US 2008/0269083 A1
(43) Pub. Date: Oct. 30, 2008

(54) Oil Reservoir Treatment Method By Injection of Nanoparticles Containing an Anti-Mineral Deposit Additive

(76) Inventors: Jean-Francois Argillier, Rueil-Malmaison (FR); David Pasquier, Suresnes (FR)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/815,872

(22) PCT Filed: Feb. 6, 2006
(86) PCT No.: PCT/FR2006/000267

§ 371 Date: Aug. 9, 2007

(30) Foreign Application Priority Data
Feb. 10, 2005 (FR) 0501370

(51) Int. Cl. C09K 8/60

(52) U.S. Cl. 507/219; 977/778; 977/962

(57) ABSTRACT

The invention relates to a method of treating permeable rocks wherein the following stages are carried out: producing particles of nanometric size comprising an active anti-mineral-deposit water-soluble polymer encapsulated in either a matrix so as to form a nanocomplex or a nanosphere, or in a membrane so as to form a nanocapsule; maintaining an amount of said particles dispersed in a liquid phase; injecting the dispersion into the permeable rock; and releasing the active polymer upon contact with salt water.

### FIELD OF THE INVENTION

The present invention relates to a method intended for preventive treatment of the area around a hydrocarbon production well and of the surrounding reservoir zones. In particular, it relates to the use of encapsulated chemical additives in form of deformable nanoparticles specific to the prevention of mineral deposits, commonly referred to as anti-scale additives. It is an “intelligent” preventive treatment of the reservoir rock in the neighbourhood of wellbores.

The invention is based on the injection, into the porous and permeable medium, of nanoparticles containing an anti-scale polymer in aqueous phase, that settle in the porous medium without substantially reducing the permeability of the reservoir rock, and diffuse a continuous polymer supply in the presence of more or less salty water.

### SUMMARY OF THE INVENTION

The present invention thus relates to a method of treating reservoir rocks, wherein the following stages are carried out:

producing particles of nanometric size comprising, in aqueous form, an active anti-scale water-soluble polymer encapsulated in either a matrix so as to form a nanocomplex, or in a membrane so as to form a nanocapsule,

maintaining an amount of said particles dispersed in a liquid phase,

injecting the dispersion into the permeable rock, and

releasing the active polymer upon contact with salt water.

The liquid phase can be aqueous, organic, or a mixture thereof.

The grain size of the particles can be small enough not to clog the permeable rock upon injection of the nanoparticles.

The grain size of the nanoparticles can be below 1 μm, and it preferably ranges around 100 nm.

The particles can be suited to adsorb on the rock to be treated. The particles can be sufficiently deformable to improve the injectivity in a porous medium.

The nanoparticles can be polycation/polyanion complexes, the polyanion being the active polymer, the cationic polymer, more or less cross-linked, or non cross-linked, forming the matrix.

The nanocapsules can be the result of an interfacial polymerization within a nano-emulsion containing the active polymer.

The active polymer can be selected from among at least one of the following polymers: polyphosphates and in particular orthophosphoric acid, organophosphorous compounds such as phosphoric acid esters, phosphonates and phosphinocarboxylic acids, synthetic polymers and copolymers based on at least one of the following monomers: acrylic, maleic or vinyl sulfonic acid, vinyl acetate, vinyl alcohol, acrylamide, and possibly comprising one or more phosphonate functions, poly-aspartates, polysaccharides (such as carboxymethylinuline, carboxymethylcellulose).

The molecular mass of the active polymer, of water-soluble type, can range between 400 and 20,000 Dalton.

The polycation can be water-soluble, and selected from among the following families: polyallylamine hydrochloride, chitosan, gelatin.

Cross-linking of the polycation can be optimized to adjust the active polymer release conditions.

### DETAILED DESCRIPTION

Other features and advantages of the invention will be clear from reading the description hereafter of non limitative examples.

The active polymer is a conventional anti-scale polymer such as a polyacrylate, polyphosphate, phosphonate, polysulfonate, of water-soluble type, of generally rather low molecular mass, ranging between 400 and 20,000 Dalton. Examples of the main inhibitors are:

polyphosphates and in particular orthophosphoric acid,

organophosphorous compounds such as phosphoric acid esters, phosphonates and phosphinocarboxylic acids,

synthetic polymers and copolymers based on acrylic, vinyl sulfonic or maleic acid, vinyl acetate, vinyl alcohol, acrylamide, possibly comprising one or more phosphonate functions,

green products such as polyaspartates, polysaccharides (such as carboxymethylinuline, carboxymethylcellulose).

According to the invention, the grain size of the particles is sufficiently small in relation to the permeability of the porous medium so that there is no risk of clogging the porous medium upon injection of the nanoparticles. The reservoir permeability must not be significantly reduced. By way of example, the grain size of the nanoparticles could be below 1 μm, and it could preferably range around 100 nm.

The nanoparticles can advantageously be deformable to facilitate injection into porous media.

According to the method, the nanoparticles are held back, at least temporarily, in the porous medium by mechanical retention or, preferably, by adsorption on the wall. Advantageously, the nanoparticles can be charged (cationic for example) or functionalized so as to best adsorb in the porous medium.

In the presence of an aqueous phase, generally salty, in particular during hydrocarbon production operations, the anti-scale active polymer can diffuse through the nanoparticle so as to act as a specific additive. As for the polymer release profile, the nanoparticles can be adjusted so as to obtain diffusion with a low concentration (of the order of 10 to 50 ppm) in salt water, formation water for example.

The nanoparticles can be either nanospheres wherein the anti-scale active polymer is entrapped in a more or less cross-linked polymer hydrogel, or in form of nanocapsules, the anti-scale active polymer being at least one of the constituents of the capsule core surrounded by a membrane.

In the case of nanospheres, one embodiment consists in forming polycation/polyanion nanocomplexes (hydrogel), the polyanion being the anti-scale active polymer, and the more or less cross-linked, or non cross-linked, cationic polymer forming the matrix (gel). A globally slightly cationic complex is formed so as to facilitate adsorption thereof on the porous medium. Examples hereafter describe the formation of nanocomplexes by controlled precipitation of cationic and anionic polyelectrolytes. The size of the nanocomplexes is controlled by various parameters such as the molecular mass of the polymers, the ratio of the concentrations of the two polyelectrolytes used, the ionic strength, possibly the pH value and possibly the cross-linking ratio of the polycation.

The nanocapsules comprising the anti-scale water-soluble polymer can be obtained in different ways, in particular from techniques consisting in forming the membrane from a nanoemulsion (also referred to as miniemulsion). There are different nanometric emulsion formation possibilities. Once the nanoemulsion formed, the membrane can be, for example, obtained by interfacial polymerization, such as polycondensation or polyaddition.

Nanoemulsions can be obtained as follows:

nanoemulsion formation by diffusion without mechanical emulsification. Diffusion from the internal phase to the continuous phase allows to carry one of the monomers to the interface of the two liquids where the polycondensation reaction with the monomers present in the external phase occurs,

nanoemulsion formation by mechanical stirring and specific selection of the system of surfactants,

nanoemulsion formation by means of membrane methods or by phase inversion (above the phase inversion temperature).

Examples of the main families of cationic polymers that can be used for complexing the inhibiting polymers are: tetraethylammonium propyl polymethacrylate, polyallylamine hydrochloride, chitosan, gelatin, or any other water-soluble cationic polymer.

During storage and injection, the nanoparticles (nanocapsules or nanospheres) can be kept dispersed, either in aqueous phase or in organic phase.

In order to control untimely release of the active additive before it is set in place, the following main functions are optimized: low level of the ionic strength, suitable pH value, release inhibitor.

The cationic polymer cross-linking function can be advantageously optimized so as to control and adjust the anti-scale active polymer release mode.

Dispersion in the organic phase can allow, on the one hand, to have a longer storage stability and, on the other hand, to minimize reservoir damage risks (due to saturation hysteresis phenomena) when setting the nanoparticles in the formation.

The examples hereafter describe the production of nanocomplexes consisting of a cationic polymer and of an anti-scale anionic polymer. The following examples are in no way limitative.

### EXAMPLE 1

### Polyaspartate/Polymadquat

The anti-scale polymer is a sodium polyaspartate (BAYPURE DS 100), a polymer of molecular mass of about 2000 g.mol⁻¹, supplied by the Bayer Company.

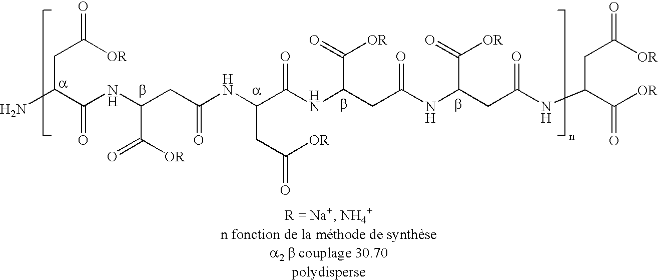

### Chemical Formula of the Polyaspartate

The polycation used was prepared by polymerization of trimethylammonium propyl methacrylamide chloride.

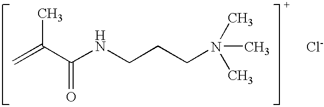

### Chemical Formula of the Trimethylammonium Propyl Metacrylate Chloride

This type of polycation can be prepared with different average molecular masses, notably approximately 10,000; 50,000 or 100,000 g.mol⁻¹. Whatever the pH value of the medium in which these polycations are present, they are constantly positively charged.

Formation of the Nanocomplexes:

a) n⁺/n⁻ charge ratio:

Insofar as the two polyelectrolytes have a different molar mass and charge density, the n⁺/n⁻ charge ratio has to be used. The existence of a critical charge ratio, which is not necessarily 1:1, has been shown. This can be explained in terms of difference in chain length, molecular mass, basicity of the ionic groups, charge density and position of the functional groups (steric factor) of the polyelectrolytes used.

The critical molar ratio for the system was evaluated by turbidimetry for the three masses of the polycation. It is close to 1.6 and not equal to 1.

The overall mass content of the two polymers is 1.5% in aqueous solution. The charge ratio was varied and the synthesis carried out with a pH value of 10. Above the critical ratio, the solution is still limpid whatever the excess amount of polycation. For charge ratios close to the critical ratio, the solution becomes cloudy and a polymer gel forms. An excess proportion of polycation in the systems leads to the formation of a positively charged complex dispersed in the solution and stabilized by electrostatic repulsions.

b) Polycation mass:

The systems described in the literature relate in most cases to polymers of great mass. Generally, interactions between heavy polyanions and polycations lead to a macroscopic phase separation, even at low temperature. The polyanion used, relatively light, does not systematically lead to a phase separation in the presence of the polycation. The results obtained are in accordance with those described in the literature: the greater the mass of the polycation, the greater the molecular mass of the complex formed. These results were established from the force flow analyses. The mass distributions of the nanocomplexes show that their size is less than 100 nm.

c) Influence of the release medium:

The first parameter to be taken into account is the ionic strength of the medium. Knowing that the coherence of the complex involves electrostatic interactions, a change in the salt concentration can disturb the system, screen the charges of the polyelectrolytes and lead to complex dissociation.

The influence of the ionic strength was studied on the macroscopic scale for charge ratios of 1.0 and 1.6 at a pH value of 10. The results are extrapolated for ratios above the critical charge ratio. Monovalent and divalent salts were studied (NaCl, KCl, CaCl₂).

When the salt concentration is increased, swelling of the nanocomplexes is first observed. From a critical concentration, the initially insoluble complex is solubilized. For the monovalent salts, this critical concentration rages between 15 and 20 g.l⁻¹. The value is much less for CaCl₂.

Considering all the results concerning the release medium, the nanocomplex may not be sufficiently resistant to the ionic strength. Upon contact with the release medium, the complex may therefore dissociate too rapidly. In order to improve this function, it is recommended to carry out cross-linking of the cationic polymer.

### EXAMPLE 2

### Polyaspartate/Gelatin

Type A gelatin can be used as another type of polycation. It is obtained by controlled hydrolysis of collagen from pig skin. It consists of proteins and its molecular mass is not well defined. It has a pH-dependent global charge with an isoelectric point close to 8. Below this threshold, its charge is globally positive, which is of interest with a view to complexing with the sodium polyaspartate.

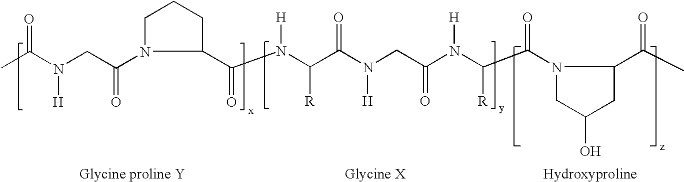

### Chemical Formula of the Type A Gelatin

This polymer of natural origin is very poorly soluble in cold water, but it hydrates readily above 40° C. Its dissolution thus occurs under heat. By temperature decrease, the gelatin thus has gelling properties at low temperature and it can be chemically cross-linked (glycine groups).

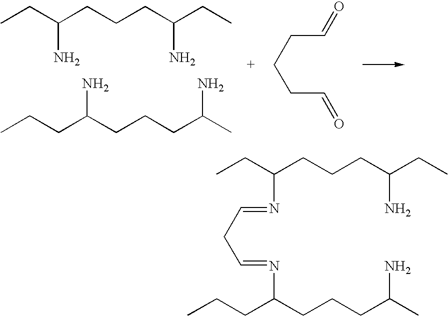

### Cross-Linking of Gelatin with Glutaraldehyde

Formation of the Nanocomplexes:

The gelatin has an isoelectric point between 7 and 9. For a pH value below the iso-electric point, it is positively charged. For pH values ranging between 3 and 5, the two electrolytes are sufficiently charged for complexing.

The gelatin affords the possibility of chemical cross-linking, which gives the nanocomplexes a certain rigidity. The cross-linking agent is glutaraldehyde. It readily reacts at ambient temperature by changing colour. The aldehyde functions react with the amine functions of the lysine residues of the gelatin chain to eventually give a Schiff base. In order to obtain more “rigid” nanocomplexes, synthesis is carried out at 40° C. so that the gelatin is soluble in water, the system is then brought to 8° C. in order to locally rigidify the gelatin chains. The cross-linking agent is added to the solution, after one hour reaction at ambient temperature, cross-linking is stopped by adding sodium bisulfite. The reaction must be carried out at a pH value allowing to have a large number of —NH₂ functions available for the cross-linking reaction.

Contacting the nanocomplexes, cross-linked or not, with a saline solution shows that only the cross-linked nanocomplexes do not solubilize, even with a high ionic strength.

Cross-linking tests were carried out on various samples containing variable (gelatin/polyaspartate) mass ratios. Under certain conditions, the cross-linked complex solutions obtained are limpid. A grain size analysis showed two particle populations around 30 and 60 nm.

### EXAMPLE 3

### Polyaspartate/Polyallylamine Hydrochloride

Polyallylamine hydrochloride is a chemically cross-linkable synthetic polycation. This polymer is commercially available (Aldrich) and its mass is 15,000 g.mol⁻¹. It is pH-dependent, the positive charges are carried by the ammonium ion. With a basic pH value, a proton is released and gives a —NH₂ amine. The presence of the amine functions allows, as in the case of the gelatin, chemical cross-linking.

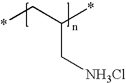

### Chemical Formula of Polyallylamine Hydrochloride

Synthesis is carried out with a pH value of 9. The mass proportion of polymers is 1.5%. The (n⁺/n⁻) charge ratio studied ranges between 0.3 and 2.5. The stability of the nanocomplexes is observed for a ratio>1.7.

### EXAMPLE 4

### Polyaspartate/Chitosan (CT)

The polyanion is the polyaspartate mentioned in Examples 1, 2 and 3. The polycation is chitosan.

Chitosan is the main derivative of chitin. Chitin, a natural polymer, is the most abundant polysaccharide on earth, together with cellulose. Its chemical structure results from the sequence of β-(1→4)-linked N-acetyl-D-glucosamine and D-glucosamine repetition units. Chitin is an important structural element of the exoskeleton of arthropods (crabs, shrimps, insects, . . . ) and of the endoskeleton of cephalopods (cuttlefish, . . . ).

Chitosan results from the deacetylation of chitin in an alkaline medium, but it also exists in a fragmented way in the natural state.

Chitin and chitosan differ in the proportion of the acetylated units present in the copolymer, also referred to as degree of acetylation (DA). Although the term “chitosan” is usually limited to any chitin sufficiently N-deacetylated to be soluble in a diluted acid medium, there is no official nomenclature with a precise limit between the two terms.

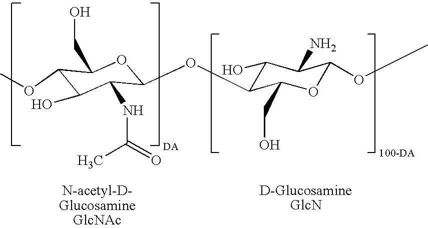

### Chemical Formula of Chitin and Chitosan

Chitosan is a polyamine that forms salts in diluted acid solutions (except for H₂SO₄ at ambient temperature) to produce a polyelectrolyte of polycation type.

Chitosan is commercially available (Aldrich, Fluka, France Quitine, Marinard), however the DA and the molar mass are not known in all cases.

Formation of the Nanocomplexes:

Their formation takes place at pH=5. The polyanion solution is added drop by drop, under magnetic stirring, to the polycation solution.

Nanocomplexes can be obtained according to the ratio of the polyelectrolyte concentrations. Concentrations of 0.1% by mass of polyaspartate and of 0.2% and 0.5% by mass of chitosan allow the formation of nanocomplexes having a size around 100 nm and a positive global charge.

Nanocomplexes Cross-Linking:

A charge value decrease is observed after cross-linking of the nanocomplexes. It changes from +35 mV for the nanocomplexes to +3 mV after cross-linking.

The size variation in the presence of a saline solution is restricted in the case of nanocomplexes that have undergone cross-linking.

This pair appears to be a good candidate for controlled release of the anti-scale polymer (polyaspartate) in the presence of salt water.

### EXAMPLE 5

### Carboxymethylinuline/Chitosan (CT)

The polycation is the chitosan of Example 4. The polyanion is carboxymethylinuline (for example the Dequest PB11625 product made by SOLUTIA). Nanocomplexes can be obtained according to the ratio of the polyelectrolyte concentrations. For example, concentrations of 0.05% by mass of carboxymethylinuline and of 0.25% and 0.5% by mass of chitosan allow the formation of nanocomplexes having a size slightly below 100 nm and a positive global charge.

### EXAMPLE 6

### Aquarite®/Chitosan (CT)

Aquarite is a commercial compound of the Rhodia Company; it is a phosphonate terminated vinyl sulfonic acid-acrylic acid copolymer. The polycation is the chitosan of Example 4. Nanocomplexes can be obtained according to the ratio of the polyelectrolyte concentrations. For example, concentrations of 0.03% or 0.05% by mass of Aquarite and of 0.5% by mass of chitosan allow the formation of nanocomplexes having a size slightly below 100 nm and a positive global charge.

1) A method of treating permeable rocks, characterized in that the following stages are carried out:
producing particles of nanometric size comprising, in aqueous form, an active anti-scale water-soluble polymer encapsulated in either a matrix so as to form a nanocomplex, or in a membrane so as to form a nanocapsule,
maintaining an amount of said particles dispersed in a liquid phase,
injecting the dispersion into the permeable rock, and
releasing the active polymer upon contact with salt water.

2) A method as claimed in claim 1, wherein said liquid phase is aqueous, organic or a mixture thereof.

3) A method as claimed in claim 1, wherein the grain size of said particles is small enough not to clog the permeable rock upon injection of the nanoparticles.

4) A method as claimed in claim 3, wherein the grain size of the nanoparticles is below 1 μm, and it preferably ranges around 100 nm.

5) A method as claimed in claim 1, wherein said particles are suited to adsorb on the rock to be treated.

6) A method as claimed in claim 1, wherein the nanoparticles are polycation/polyanion complexes, the polyanion being the active polymer in aqueous form, the cationic polymer, more or less cross-linked, or non cross-linked, forming the matrix.

7) A method as claimed in claim 1 wherein the nanocapsules are the result of an interfacial polymerization within a nanoemulsion containing the active polymer in aqueous phase.

8) A method as claimed in claim 1, wherein the active polymer is selected from among at least one of the following polymers: polyphosphates and in particular orthophosphoric acid, organophosphorous compounds such as phosphoric acid esters, phosphonates and phosphinocarboxylic acids, synthetic polymers and copolymers based on at least one of the following monomers: acrylic, maleic or vinyl sulfonic acid, vinyl acetate, vinyl alcohol, acrylamide, and possibly comprising one or more phosphonate functions, polyaspartates, polysaccharides (such as carboxymethylinuline, carboxymethylcellulose).

9) A method as claimed in claim 8, wherein the molecular mass of the active polymer, of water-soluble type, ranges between 400 and 20,000 Dalton.

10) A method as claimed in claim 6, wherein the polycation is water-soluble, and selected from among the following families: polyallylamine hydrochloride, chitosan, gelatin.

11) A method as claimed in claim 6, wherein cross-linking of the polycation is optimized to adjust the active polymer release conditions.
